(19) United States
(12) Patent Application Publication
(10) Pub. No.: US 2004/0063596 A1
(43) Pub. Date: Apr. 1, 2004

(54) Photochromic photo resist composition

(75) Inventors: Sandra Gabric, Mountainview, CA (US); Sunder Ram, San Jose, CA (US); Paul Wickboldt, Walnut Creek, CA (US)

Correspondence Address: William L. Botjer, PO Box 478, Center Moriches, NY, 11934, US

(73) Assignee: Flexics, Inc.

(21) Appl. No.: 10/261,270

(22) Filed: Sep. 30, 2002

(51) Int. Cl. C11D 1/00

(52) U.S. Cl. 510/176

(57) ABSTRACT

A photochromic photo resist composition that changes color on exposure to radiation; thereby providing a distinctive visible interface between exposed and non-exposed areas. In the composition, 0.2-5% of a photochromic dye solution is prepared in hot toluene. Twenty parts of the dye solution is then added slowly to the photo resist under mild agitation, thereby forming the color changing photo resist. The color changing property of the photo resist facilitates alignment of mask patterns in continuous patterning of images on a large substrate.

### BACKGROUND

The invention relates to photolithographic compounds. More particularly, the invention relates to a photo resist composition, which exhibits a visible color change on exposure to radiation.

The process of manufacturing semiconductors, or integrated circuits consists of a multitude of steps, during which hundreds of copies of an integrated circuit are formed on a single substrate. Generally, the process involves the creation of a number of patterned layers of circuits on and into the substrate or the silicon wafer, ultimately forming the complete integrated circuit.

Photolithography or photo masking techniques are used to transfer a desired pattern of a circuit onto the substrate. Photolithography uses ultraviolet (UV) or X-ray lithography for transmitting a desired pattern into a photo resist. A layer of photo resist or light-sensitive film is applied to the substrate. Photo resist is a material that reacts on exposure to radiation such as UV light, X-rays, and e-beam. The photo resist layer either hardens or softens on exposure to radiation depending on the type of photo resist. A photo aligner is used to align the substrate, layered with the photo resist, with a mask so that a pattern can be transferred onto the substrate surface.

Relative alignment between the mask and the substrate is an important factor for establishing the performance of semiconductor devices. Particularly in the recent generation of integrated circuits, a submicron level of accuracy in alignment is required for effecting large-scale integration of semiconductor devices. Sensing the position of the previous pattern written on the substrate and aligning that pattern to the next pattern, and controlling the alignment during wafer fabrication is one of the key technical challenges for advancing semiconductor lithography.

Recently there has been considerable interest and work towards fabricating integrated circuits in roll-to-roll format. In this process, a long sheet or web of a substrate such as plastic, stainless steel etc. is unrolled from one spool, covered with circuit board-like patterns of silicon, and rolled onto another spool. Roll-to-roll technology is particularly useful in cases of low-density applications where transistors can be spread out over a large surface area. In order to form a continuous pattern in roll-to-roll technology, each exposure frame or mask must be aligned to the previous image of the pattern on the substrate. To make effective use of roll-to-roll technology, photolithography equipment should have very fine alignment capabilities.

Conventionally, registration marks are used for alignment purposes. These registration marks are provided on the mask frame and the substrate. Alignment between the frame and the substrate is performed using the positional information obtained from registration marks. This alignment is typically performed using machine vision or recognition systems that automatically align the substrate and the mask using the registration marks.

Currently used techniques for alignment in roll-to-roll technology include making sprocket holes on the roll, which act as registration marks for alignment. Thereafter, the alignment is mechanically done. This technique provides for a precision level of 20-50 microns, which is too large for many envisioned circuit products.

The aligners employed in roll-to roll technology align the mask pattern frames using registration marks on the substrate and expose a pattern one frame at a time. Therefore, to form a continuous pattern using such an aligner, each exposure frame must be aligned to the previous pattern in succession. However, such successive alignment is not possible using conventional photo resists since the exposed photo resist does not provide a visible indication of where it was exposed.

Currently used photo resists for photolithography do not provide a visible indication of exposure to radiation (exposure patterns appear only after a chemical developer process). Therefore, facilitating alignment of a frame with the previous image is not possible without the use of special registration marks. Further, compositions that change color on exposure to radiation, have very low solubility in existing photoresists, and therefore cannot be added to photoresists to form a photochromic photoresist.

Therefore, there exists a need for a photochromic photo resist composition that exhibits a visible indication of exposed surface by changing color on exposure to radiation such that it facilitates successive alignment of exposure frames to a preexisting image of a pattern on a substrate for continuous patterning.

### SUMMARY

An object of the present invention is to provide a photo resist that changes color on exposure to radiation.

Another object of the present invention is to provide a visible interface between exposed and non-exposed surface of photo resist for facilitating alignment of mask frames to the substrate in micro-device fabrication.

Yet another object of the present invention is to devise a photochromic photo resist composition, which can facilitate the forming of continuous mask patterns on substrates of large area, by providing a distinctive interface between exposed and non-exposed areas on the substrate.

The invention provides a photo resist composition that changes color on exposure to radiation, thereby providing a distinctive interface between exposed and non-exposed areas. In the composition, 0.2-5% of a photochromic dye solution is prepared in hot toluene. Twenty parts of the dye solution is then added slowly to the photo resist under mild agitation, thereby forming the color-changing photo resist composition. The color changing property of the photo resist facilitates alignment of mask patterns in continuous patterning of images on a large substrate.

These and other features, aspects, and advantages of the present invention will become better understood with reference to the following description and appended claims.

### DESCRIPTION

The present invention provides for a photo resist composition that changes color on exposure to radiation. The composition is obtained by adding a photochromic dye solution to a photo resist. The photochromic dye solution provides the color changing property to the photo resist composition thus prepared. When this photo resist composition is exposed to radiation, the composition provides a visible indication of the area where the photo resist composition was exposed.

The photochromic dye solution is prepared by dissolving a photochromic substance in a non-aqueous solvent. The photochromic substance may be a photochromic dye. The essential property of the photochromic substance used in the composition is that the substance changes color on exposure to radiation such as ultraviolet radiation and e-beam. UV light reversibly changes the molecular structure of the photochromic material and makes it absorb color in the visible range.

Photochromic dyes are crystalline powders in their natural state. Therefore, a solution of photochromic dye needs to be formed so that the photochromic dye can be mixed with the photo resist. The solvent used to dissolve the crystalline powder should be compatible with the photo resist. In other words, the photochromic dye solution should readily mix with the photo resist and form a uniform photo resist composition. In a preferred composition, hot toluene is used as the solvent. The temperature at which crystalline photochromic dye is soluble in toluene ranges from 70° C. to 110° C.

The dye solution thus prepared is added slowly to the photo resist under mild agitation. The photo resist used in the composition can be any positive photo resist or negative photo resist.

Constituents of the particular color changing photochromic photo resist composition are now described.

Photochromic Dye

The photochromic substance that can be used in the present invention includes a photochromic dye Photopia® color, a registered trademark of Matsui Shikiso Chemical Co. Ltd., Kyoto, Japan, which is disclosed in U.S. Pat. No. 5,431,697. The color patterning composition described in the patent is a granulated material such as pellets, beads and the like. The granulated material is prepared using a blend of uncured olefin polymer with a reversibly variable color material. The resultant granulated material is subjected to cross linking reaction to provide a reversibly variable color patterning composition. The reversibly variable color material disclosed in the patent is a thermo chromic material or a photochromic material. For the purpose of the present invention, the color patterning composition that uses a photochromic material as the reversibly variable color material is used.

Photopia® color samples that have been tested include Photopia® purple, Photopia® blue and Photopia® yellow. Photopia® purple colorant has a wavelength of maximum absorption at 578 nm at the time of color exhibition.

Another photochromic dye that can be used is Photosol® photochromic dye manufactured by PPG Industries Inc. Pittsburgh, Pa., USA. The Photosol samples Photosol® 7-106, Photosol® 0265 and Photosol® 5-3 may be used.

Although certain photochromic dyes have been mentioned, it is apparent to one skilled in the art that other photochromic dyes which are soluble in a non-aqueous solvent, which in turn is compatible with a photo resist, can be used without deviating from the scope of the invention.

Solvent

A non-aqueous solvent is used for preparing the solution of the photochromic dye. In a preferred mode, the dye solution was prepared in hot toluene. Another non-aqueous solvent that can be used is xylene. Photochromic dye Photopia® purple has a solubility of 2% in toluene and xylene. Other solvents that can be used include hydrocarbons like n-hexane, cyclohexane, methyl cyclohexane; halogenated hydrocarbons like carbon tetrachloride, trichloro benzene; ketones like methyl ethyl ketone and cyclohexanone, ethyl acetate, butyl acetate and other solvents like nitro ethane, DMF and ethyl cellosolve.

Photo Resist

A positive photo resist is used for forming the photo resist composition. According to the preferable composition, positive photo resist AZ(R) 1512-SFD manufactured by Clariant Corp. AZ electronic materials, Somerville, N.J., USA is used. Composition of this photo resist includes 74% by weight of 1-methoxy-2-propanol acetate, less than 30% by weight of cresol-novolak resin and less than 10% by weight of diazonaphthoquinonesulfonic ester.

Positive photo resist XP 1616C manufactured by Shipley Company, Marlborough, USA and positive photo resist HPR 504 manufactured by Arch Chemicals, Inc. Norwalk, Conn., USA are examples of other photo resists that may be used.

Although certain photo resists have been mentioned, it is apparent to one skilled in the art that other photo resists which are compatible with photochromic dye solution can be used without deviating from the scope of the invention.

### EXAMPLES

The following examples are intended to describe the invention in further detail.

### Example 1

One part by weight of photochromic dye Photopia® purple (trademark Matsui Shikiso Chemical Co. Ltd., Japan) was added to a 19 parts by weight of hot solution of toluene at 80° C. under mild agitation. Photopia®) purple is a light yellow powder that changes color reversibly on exposure to sunlight or UV light. The solution was cooled and added slowly and under mild agitation to 100 parts by weight of AZ (R) 1512-SFD photo resist of Clariant Corp, AZ Electronic Materials, Somerville, N.J., USA.

The resultant mixture was spun onto plastic 6″ substrate to form a 1-2 micron thick coating. The substrate was then exposed to broadband UV light on the photolithography tool. The exposed photochromic material in the resist was excited at wavelengths of 365 nm and 405 nm and it exhibited a color change from colorless to purple. A stark contrast was observed between exposed and non-exposed areas.

### Example 2

0.4 parts by weight of photochromic dye Photopia® purple (trademark Matsui Shikiso Chemical Co. Ltd., Japan) was added to 19.6 parts by weight of hot solution of toluene at 80° C. under mild agitation. Photopia® purple is a light yellow powder that changes color reversibly on exposure to sunlight or UV light. The solution was cooled and added slowly and under mild agitation to 100 parts by weight of AZ (R) 1512-SFD photo resist of Clariant Corp, AZ Electronic Materials, Somerville, N.J., USA.

The resultant mixture was spun onto plastic 6″ substrate to form a 1-2 micron thick coating. The substrate was then exposed to broadband UV light on the photolithography tool. The exposed photochromic material in the resist was excited at wavelengths of 365 nm and 405 nm and it exhibited a color change from colorless to purple.

The photo resist composition as disclosed in the current invention, can be used for achieving high-precision, continuous, large-area pattern formation using conventional photolithography aligners. This is particularly useful in case of roll-to-roll technology where each exposure frame must be aligned to the previous image in succession. Using the photo resist composition as described in the current invention, continuous patterns can be formed along the length of a roll-to-roll web of indefinite length, with the mask patterns closely aligned to each other, with less than a micron overlay between the patterns.

The visible color contrast observed in the photo resist composition, between the exposed and non-exposed surface, facilitates alignment of subsequent exposure pattern frames to the already formed image on the substrate. The color of such a photo resist changes wherever the substrate has been exposed to radiation. A distinctive visible interface between exposed and non-exposed areas is thus formed. This distinctive interface is used as an indicator to align mask patterns continuously along the surface of the substrate. The aligning of mask patterns is done using photoaligners.

Some conventional photoaligners that can utilize the above mentioned technique are proximity or contact aligners such as the Karl Suss MA100RR, the OLEC AX28 Reel-to-Reel, the Perkin Elmer ProForm or Ushio UX-3100SR, as well as projection aligners such as the Ushio UX-2123SR. All these tools can expose a web by the “step and repeat” method, where the web is advanced and exposed successively, generating a series of the same image. These systems can have alignment tools that use image-recognition technology to align the image to pre-existing registration marks. These alignment systems can achieve overlay accuracies well below 1 micron if necessary.

The photo resist composition can also be used in general to form continuous patterns that exceed the size of a given exposure frame. They can be used in general for webs, panels or wafers of plastic, glass, metal, or any other material used for such processing.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A photo resist composition comprising:
a. a photo resist;
b. a photochromic substance, the photochromic substance changing color on exposure to radiation; and
c. a non-aqueous solvent for dissolving the photochromic substance.

2. The photo resist composition of claim 1 wherein the photo resist is a positive type photo resist.

3. The photo resist composition of claim 1 wherein the photochromic substance is a photochromic dye.

4. The photo resist composition of claim 1 wherein the non-aqueous solvent is toluene.

5. The photo resist composition of claim 1 wherein the non-aqueous solvent is selected from the group consisting of n-hexane, cyclohexane, methyl cyclohexane, xylene, carbon tetrachloride, trichloro benzene, methyl ethyl ketone, cyclohexanone, ethyl acetate, butyl acetate, nitro ethane, DMF and ethyl cellosolve.

6. A photochromic photo resist composition for providing visible indication of exposed surface on exposure to radiation, the photo resist composition comprising:
a. a photochromic substance dissolved in a non aqueous solvent, the photochromic substance dissolved 1-0.4 parts by weight in 19-19.6 parts by weight of the solvent; and
b. a photo resist, the photo resist being 100 parts by weight for 20 parts by weight of the solution of photochromic substance in the non-aqueous solvent.

7. The photo resist composition of claim 6 wherein the photo resist is a positive type photo resist.

8. The photo resist composition of claim 6 wherein the non-aqueous solvent is toluene.

9. The photo resist composition of claim 6 wherein the non-aqueous solvent is selected from the group consisting of n-hexane, cyclohexane, methyl cyclohexane, xylene, carbon tetrachloride, trichloro benzene, methyl ethyl ketone, cyclohexanone, ethyl acetate, butyl acetate, nitro ethane, DMF and ethyl cellosolve.

10. The photo resist composition of claim 6 wherein the photochromic substance is a photochromic dye.

11. A process for forming a photo resist composition that exhibits color change on exposure to radiation, the process comprising the steps of:
a. mixing a weighted amount of a photochromic substance in a non-aqueous solvent under mild agitation; and
b. adding the solution of photochromic substance in the solvent to a weighted quantity of photo resist.

12. The process as recited in claim 11 wherein the non-aqueous solvent is toluene.

13. The process as recited in claim 11 wherein the non-aqueous solvent is selected from the group consisting of n-hexane, cyclohexane, methyl cyclohexane, xylene, carbon tetrachloride, trichloro benzene, methyl ethyl ketone, cyclohexanone, ethyl acetate, butyl acetate, nitro ethane, DMF and ethyl cellosolve.

14. The process as recited in claim 11 wherein the photochromic substance is mixed in a hot solution of the non-aqueous solvent.

15. A method of forming continuous mask patterns on a substrate of large area, the method comprising the steps of:
a. applying a layer of a color changing photo resist composition onto the surface of the substrate to form a coating,
b. exposing surface of the substrate coated with the photo resist composition to radiation, the photo resist composition exhibiting visible change in color in response to exposure to radiation, whereby a distinctive visible interface is exhibited between exposed and non-exposed surface of the substrate; and
c. aligning mask patterns continuously along the surface of the substrate using the distinctive interface as an indicator.

16. The method as recited in claim 15 wherein the color changing photo resist composition comprises:
a. a photo resist;
b. a photochromic substance, the photochromic substance changing color on exposure to radiation; and
c. a non-aqueous solvent for dissolving the photochromic substance;

17. The method as recited in claim 15 wherein thickness of the photo resist coating formed on the substrate lies in the range of 1-5 μm.
